(19) United States
(12) Patent Application Publication
(10) Pub. No.: US 2005/0042371 A1
(43) Pub. Date: Feb. 24, 2005

(54) Method for manufacturing optical disc and apparatus for manufacturing optical disc

(75) Inventors: Tomoki Ushida, Tokyo (JP); Kenji Yamaga, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 10/919,313

(22) Filed: Aug. 17, 2004

(30) Foreign Application Priority Data
Aug. 18, 2003 (JP) 2003-207747

(51) Int. Cl. B05D 5/06

(52) U.S. Cl. 427/240; 427/162; 118/52

(57) ABSTRACT

A method for manufacturing an optical disc by forming at least one recording layer on a substrate with a temporary center hole and then forming a light transmitting layer on the recording layer includes a step of covering the lower end of the temporary center hole, a step of providing droplets containing a material for forming the light transmitting layer into the resulting temporary center hole, and a step of subjecting the material for forming the light transmitting layer to a spin coating process. In the method, the lower end of the temporary center hole is covered with a sealing member. An apparatus for manufacturing an optical disc by the method includes retaining sections for retaining the substrate, an affixing section for covering the lower end of the temporary center hole, and a spinner plate.

### BACKGROUND OF THE INVENTION

1. Field of the Invention

The present invention generally relates to methods for manufacturing optical discs and apparatuses for manufacturing such optical discs. The present invention particularly relates to a method for manufacturing an optical disc, covered with a coating with a uniform thickness, having a small diameter and also relates to an apparatus for manufacturing such an optical disc.

2. Description of the Related Art

Optical discs, such as Blu-ray Disc that has been recently developed and introduced to the market, having a large number of apertures are equipped with thin, light transmitting layers that generally have thickness of about 100 μm. There are various processes for forming such light transmitting layers. Among those processes is a spin coating process, which is advantageous in manufacturing cost. The spin coating process is one of coating processes in which a coating solution is applied dropwise to a disc and then spread over the disc by rotating the disc, whereby a coating is formed on the disc. In the spin coating process, a coating with a desired thickness can be formed by appropriately adjusting the viscosity of the solution or the rotating speed.

In general, substrates for optical discs each have a hole at the center because the substrates must be readily stacked in a shaping step and a mask must be securely retained on each substrate in a sputtering step. Therefore, in contrast to flat sheets such as semiconductor wafers, a coating solution cannot be applied to the center area of the substrate; hence, a coating is formed by a spin coating process in such a manner that the solution is applied onto an outer area surrounding the center area. Therefore, there is a problem in that the gradient of the coating thickness ranges from the center area to an edge area and reaches about 10% at the maximum.

For example, the following documents disclose techniques for forming uniform coatings on disc substrates by a spin coating process: Japanese Unexamined Patent Application Publication Nos. 11-195250, 11-213459, 11-66647, and 2002-184047 hereinafter referred to as Patent Documents 1, 2, 3, and 4, respectively. According to those techniques disclosed in the documents, a coating is formed on a substrate in such a manner that a hole at the center of the substrate is covered with a rotary disc, a cap, etc., whereby the coating is allowed to have a uniform thickness. Japanese Unexamined Patent Application Publication No. 2001-246643 hereinafter referred to as Patent Document 5 discloses a recording medium that has a recessed portion, instead of a center hole, for rotation alignment and a portion for retaining a substrate. Japanese Unexamined Patent Application Publication No. 2003-33713 hereinafter referred to as Patent Document 6 discloses a technique in which a cured coating with a uniform thickness is formed in such a manner that the viscosity of a liquid resin is adjusted by allowing a substrate surface to have a temperature distribution. Japanese Unexamined Patent Application Publication No. 10-40584 hereinafter referred to as Patent Document 7 discloses a technique in which a coating is formed on a substrate having no center hole and the center of the resulting substrate is then punched out to form a hole.

As described above, various techniques for forming coatings on disc substrates by the spin coating process have been proposed. Those techniques are used to process 120 mm diameter discs that each have a center hole with a diameter of 15 mm and a recording region extending from a radius of about 20 mm to 59 mm. However, those techniques are not used to process smaller diameter discs each having a recording region extending from a radius of about 8 mm to 14.5 mm. Therefore, coatings with a uniform thickness can be formed on such large diameter discs with a thickness distribution of several percents but cannot be formed on such smaller diameter discs by known processes.

For the spin coating process performed in such a manner that a center hole of a disc is covered with one of various jigs described in Patent Documents 1 to 4, the disc can be treated by reducing the size of the jig and handling tools; however, reverse effects of the jig on such a small recording region cannot be completely eliminated and a thickness distribution exceeding a requirement cannot therefore be prevented. For a process in which a thin sheet is affixed to a substrate to cover a center hole, a disc with low thickness distribution can be obtained; however, linear coating defects are formed due to steps caused by the sheet with a thickness of about 10 to 50 μm and/or an uncovered portion in some cases. Furthermore, it is substantially impossible to achieve an apparatus for continuously and precisely affixing a small sheet to a substrate without damaging a recording face and without misalignment and this process has a problem in productivity.

For the technique disclosed in Patent Document 5 in which the recording medium has the recessed portion and the retaining portion, a narrow region that is adjacent to the retaining portion and extends to a radius of about 30 mm has a difference in coating thickness of about 5 to 20 μm, that is, a coating with a uniform thickness cannot be formed on such a narrow region. For the technique disclosed in Patent Document 6 in which the temperature distribution is used, a coating with a uniform thickness meeting a requirement cannot be substantially formed by adjusting the coating thickness over a small region having the same size as the above on the order of several micrometers.

For the technique disclosed in Patent Document 7 in which the substrate with no center hole is used, a small diameter area has a coating with a uniform thickness. However, since the substrate has no center hole, a position which is close to the center of the substrate and to which a mask portion is fixed cannot be physically identified; hence, there is a problem in that a ring-shaped sputtering area cannot be substantially formed. Such a sputtering area can be formed using an auxiliary force such as a magnetic force; however, this operation has a problem in that alignment accuracy is not high and the reproducibility of a unit for removing a magnet is not high. High eccentric accuracy cannot be achieved in a punching step subsequent to a coating step and the substrate is not easy to handle and easy to stack in a shaping step or the coating step; hence, this technique is inferior in productivity.

### SUMMARY OF THE INVENTION

It is an object of the present invention to provide a method for manufacturing a practical optical disc and an apparatus for manufacturing such an optical disc, in which a coating with a uniform thickness can be formed by a spin coating process even though the optical disc has a small diameter and the productivity and the usability are superior.

In order to solve the above problems, the inventors have made an intensive investigation. As a result, the inventors found that a light transmitting layer with a uniform thickness can be formed on a narrow region of a disc with high yield without causing the distribution of layer thickness using the method and apparatus described below and then completed the present invention.

A first aspect of the present invention provides a method for manufacturing an optical disc by forming at least one recording layer on a substrate with a temporary center hole and then forming a light transmitting layer on the recording layer. The method includes a step of covering the lower end of the temporary center hole, a step of providing droplets containing a material for forming the light transmitting layer into the resulting temporary center hole, and a step of subjecting the material for forming the light transmitting layer to a spin coating process by rotating the substrate.

The method described above preferably further includes a step of curing the material for forming the light transmitting layer spread around the temporary center hole in such a manner that the lower end of the temporary center hole is covered. In the method, the substrate preferably has a tapered portion of which the thickness is gradually reduced from the inner edge of the recording layer toward the temporary center hole in whole or in part. Furthermore, the light transmitting layer formed by curing the material for forming the light transmitting layer subjected to the spin coating process preferably has a recessed portion, located above the temporary center hole, having a slope with an angle of inclination of 7° or less. The lower end of the temporary center hole may be covered with a sealing member.

The method of the present invention is suitable for manufacturing a small diameter disc having a recording region extending from a radius of about 8 mm in particular. According to the method, a coating with a uniform thickness can be formed above such a small diameter disc by a spin coating process.

A second aspect of the present invention provides an apparatus for manufacturing an optical disc by the method. The apparatus includes retaining sections for retaining the substrate, an affixing section for covering the lower end of the temporary center hole, and a spinner plate.

According to the apparatus of the present invention, the substrate can be retained and the temporary center hole can be covered readily and securely; hence, the method can be efficiently performed.

The method and apparatus of the present invention are both superior in productivity and suitable for manufacturing an optical disc that is superior in practical use.

### BRIEF DESCRIPTION OF THE DRAWINGS

FIG. 1 is a schematic view illustrating a preferable example of a method for manufacturing an optical disc according to the present invention;

FIG. 2 is a schematic view showing a preferable example of an apparatus provided with a spinner plate for manufacturing an optical disc according to the present invention and also illustrating the method; and

FIG. 3 is an enlarged sectional view showing an optical disc, used in an example of the present invention, having a temporary center hole.

### DESCRIPTION OF THE PREFERRED EMBODIMENTS

Embodiments of the present invention will now be described in detail.

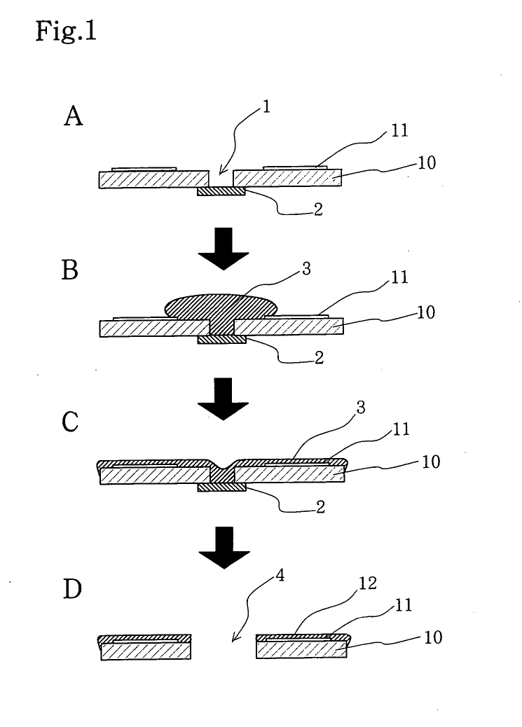

FIG. 1 is a schematic view illustrating a preferable example of a manufacturing method according to the present invention. With reference to FIG. 1A, a substrate 10 has a temporary center hole 1 and a recording layer 11 is placed on the substrate 10. The present invention is characterized in that a spin coating process is performed in such a manner that the lower end of the temporary center hole 1 is covered with a sealing member 2. As shown in FIG. 1B, droplets containing a material for forming the light transmitting layer 3 are provided into the temporary center hole 1 of which the lower end is covered. The resulting substrate 10 is then spun, whereby a coating of the material for forming the light transmitting layer 3 is formed over the recording layer 11 as shown in FIG. 1C. The coating is irradiated with UV rays or the like, thereby curing the material for forming the light transmitting layer 3 to form a light transmitting layer 12. The center of the resulting substrate 10 is punched out, thereby forming a final center hole 4 having a diameter greater than that of the temporary center hole 1 to obtain an optical disc having the final center hole 4 as shown in FIG. 1D. Alternatively, the temporary center hole 1 may have the same diameter as that of the final center hole 4. In this case, after the light transmitting layer 12 is formed, a portion of the light transmitting layer 12 in the temporary center hole 1 is punched out, whereby the same configuration as the above can be obtained.

According to the present invention, coatings are not affected by jigs, retaining units, and the like used in known processes; hence, a coating with a uniform thickness that meets a requirement can be formed even on a narrow region. Furthermore, coating defects due to thin sheets affixed to substrates can be prevented. Since the substrate 10 having the temporary center hole 1 is used, the substrate 10 can be readily stacked on a table in a shaping step and a mask can be securely retained on the substrate 10 in a sputtering step; hence high productivity can be achieved.

In the present invention, as shown in FIG. 1, it is critical to perform the spin coating process in such a manner that the lower end of the temporary center hole 1 is covered. A particular technique for covering the lower end of the temporary center hole 1 is not particular limited and the sealing member 2 may be affixed to the lower face of the substrate 10 as shown in FIG. 1. The sealing member 2 is not particular limited and examples of the sealing member 2 include an ordinary adhesive sheet. The size and shape of the sealing member 2 are not particular limited and the sealing member 2 preferably has a size sufficient to cover the temporary center hole 1 or a size greater than that of the final center hole 4. Therefore, the present invention is superior in productivity in this respect.

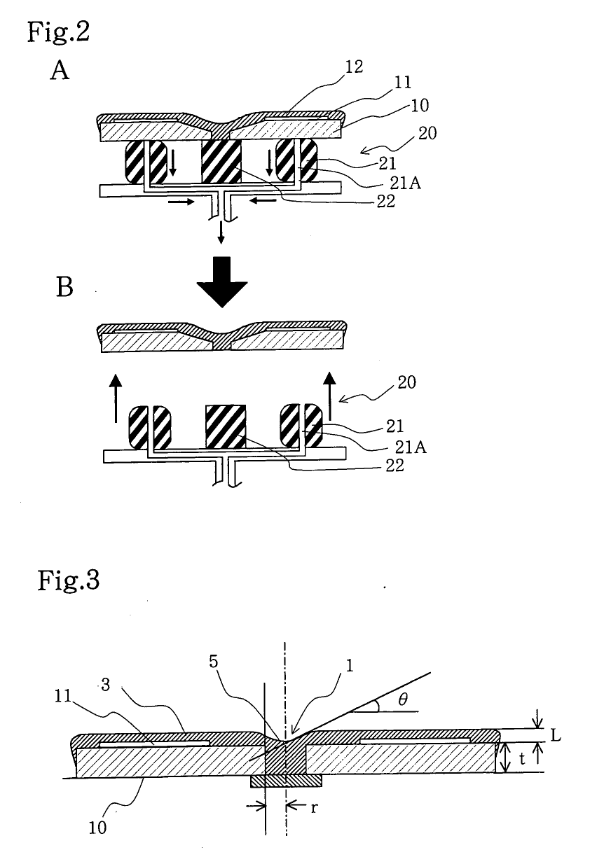

In order to cover the lower end of the temporary center hole 1, a manufacturing apparatus including a spinner plate 20 shown in FIG. 2 may be used. The spinner plate 20 includes retaining sections 21, each including corresponding aspiration units 21A placed therein, for retaining the substrate 10 and an affixing section 22 for covering the lower end of the temporary center hole 1. The upper face of the affixing section 22 is affixed to a region surrounding the temporary center hole 1.

In order to securely fix the affixing section 22 shown in FIG. 2 to the substrate 10, the affixing section 22 preferably contains a silicone resin with rubber elasticity or at least one of the following polymers and resin that have high smoothness and can be readily removed from the cured light transmitting layer 12: polypropylene, polyethylene, and a fluorine resin. The affixing section 22 may be surface-treated or covered with at least one of those polymers and resins. The size and shape of the affixing section 22 as well as the sealing member 2 are not particular limited and the sealing member 2 as well as the sealing member 2 may have any size and shape suitable to cover the temporary center hole 1. Since the retaining sections 21 must be securely fixed to the substrate 10 and must retain the substrate 10, contact regions of the retaining sections 21 fixed to the substrate 10 preferably contain a material that has high smoothness and is suitable to securely join the retaining sections 21 to the substrate 10 by allowing the aspiration units 21A to aspirate air. In the spinner plate 20, the retaining sections 21 have a height slightly greater than or equal to that of the affixing section 22. Therefore, the retaining sections 21 can be securely fixed to the substrate 10 by allowing the aspiration units 21A to aspirate air and can therefore retain the substrate 10, and the affixing section 22 can securely cover the temporary center hole 1.

In the present invention, the material for forming the light transmitting layer 3 remaining in and spread around the temporary center hole 1 by the spin coating process is preferably cured in such a manner that the lower end of the temporary center hole 1 is covered. If the substrate 10 is separated from the spinner plate 20 without curing the material for forming the light transmitting layer 3, the uncured material for forming the light transmitting layer 3 leaks out of the temporary center hole 1 and then adheres to the spinner plate 20 to soil the manufacturing apparatus and the rear face of a subsequent substrate. Therefore, the material for forming the light transmitting layer 3 remaining in and spread around the temporary center hole 1 is preferably cured with radiation in such a manner that the lower end of the temporary center hole 1 is covered, whereby the soiling is prevented from occurring. The material for forming the light transmitting layer 3 is cured during or at the end of the spin coating process. After the curing is finished, the resulting substrate 10 is processed in a punching step and then in another step, whereby the optical disc having the final center hole 4 and the light transmitting layer 12 with desired properties is obtained.

The substrate 10 used herein must have the temporary center hole 1 that is necessary to stack the substrate 10 precisely and necessary to retain a mask securely but does not have any particular limitations. The substrate 10 may have an arbitrary diameter and/or thickness. The size and shape of the temporary center hole 1 are not particular limited. However, in order to allow the light transmitting layer 12 to have a uniform thickness, it is critical to appropriately select the diameter and shape of the temporary center hole 1 depending on the thickness of the substrate 10 and that of the light transmitting layer 12.

In order to manufacture each small diameter disc, described above, having a diameter of about 30 mm and including a recording region extending from a radius of about 8 to 14.5 mm, the temporary center hole 1 may have a diameter of about 1 to 4 mm when the substrate 10 has a thickness of about 0.3 to 1.2 mm. Since the diameter of the temporary center hole 1 is preferably large in view of ease in handling the substrate 10, the temporary center hole 1 preferably has a diameter of about 2 to 3 mm. The final center hole 4 preferably has a diameter of about 5 mm. For example, for Blu-ray Disc, a light transmitting layer placed on a recording region must have a thickness of about 100±2 μm, which is a requirement necessary for blue-laser optical discs. According to the present invention, an optical disc that satisfies such a requirement can be manufactured using the small diameter substrate.

As shown in FIG. 2, a region surrounding the temporary center hole 1 preferably decreases in thickness from the inner edge of the recording layer 11 toward the temporary center hole 1. Since the upper face of the region surrounding the temporary center hole 1 is sloped down toward the temporary center hole 1 as shown in FIG. 2, coating streaks due to the edge of the temporary center hole 1 can be securely prevented from being formed on the surrounding region. The whole of the upper face of the surrounding region is preferably sloped down from the inner edge of the recording layer 11 toward the temporary center hole 1. Even if a portion of the upper face thereof is sloped, such coating streaks can be prevented from being formed. The inner edge of the substrate 10 surrounding the temporary center hole 1 preferably has a height as small as possible depending on the thickness of the substrate and the slope extending from the inner edge of the recording layer 11 to the temporary center hole 1 is preferably gentle. According to such a configuration, coating formation can be appropriately performed.

As shown in FIG. 3 in an enlarged manner, the light transmitting layer 12 formed by curing the material for forming the light transmitting layer 3 subjected to the spin coating process usually has a recessed section 5, located above the temporary center hole 1, having a slope. In the present invention, the slope of the recessed section 5 preferably has an angle of inclination of 7 degrees or less and more preferably 5 degrees or less. The light transmitting layer 12 having no coating streaks can be uniformly formed by adjusting the angle of inclination to a value within the above range. In particular, the angle of inclination can be determined depending on the thickness of the substrate 10 and the diameter of the temporary center hole 1.

In the method for manufacturing an optical disc according to the present invention, the above requirements necessary for the step of forming the light transmitting layer 12 by the spin coating process must be satisfied. Conditions of other manufacturing steps, the layer structure of the optical disc, and a material for forming the optical disc, and the lake are not particular limited and can be accordingly selected in accordance with a usual practice. The manufacturing apparatus of the present invention is not particularly limited except that the apparatus has the spinner plate 20 shown in FIG. 2 and a configuration of the apparatus may be selected in accordance with a usual practice.

### EXAMPLES

The present invention will now be described with examples.

Samples were prepared using substrates 10, shown in FIGS. 1 and 3, each including corresponding recording layers 11 placed thereon. Each substrate 10 had a diameter of 30 mm, a thickness of 0.1 to 1.2 mm, and a temporary center hole 1 with a diameter of 1.0 to 4.0 mm (a radius of 0.5 to 2.0 mm) and included a recording region extending from a radius of 8 to 14.5 mm. A light transmitting layer 12 with a thickness of 100 μm was formed on the substrate 10 by a spin coating process according to the following procedure: droplets containing a material for forming the light transmitting layer 3 that has a viscosity of 5,000 mPa•s (cPs) and contains a UV curable resin were provided into the temporary center hole 1 in such a manner that the lower end of the temporary center hole 1 was covered with a sealing member 2 as shown in FIG. 1B; a spinner plate was fixed to the resulting substrate 10 and then rotated at 2,000 rpm for about ten seconds, thereby forming a coating containing the material for forming the light transmitting layer 3 as shown in FIG. 1C; and the coating is irradiated with UV rays using a high-pressure mercury lamp, thereby curing the coating to form the light transmitting layer 12.

The light transmitting layer 12 had a recessed portion, located above the temporary center hole 1, having a slope. The angle θ (°) of inclination of the slope was measured with a surface scanner. In order to evaluate the light transmitting layer 12 for coating evenness, the light transmitting layer 12 was checked in the circumferential direction by visual inspection whether there are any linear coating defects around the temporary center hole 1 and checked for thickness distribution of the light transmitting layer 12 using a thickness meter. When the light transmitting layer 12 has linear coating defects, a pickup cannot focus on the light transmitting layer 12; hence an obtained optical disc cannot be read or written.

Furthermore, in order to evaluate the light transmitting layer 12 for thickness distribution, the light transmitting layer 12 was measured for thickness with a laser focus displacement meter. When a difference in thickness is about 4 μm, signal intensity varies to cause errors during the replay of optical discs.

Obtained results are shown in Table 1. With reference to Table 1, t represents the thickness of the substrate 10, r represents the radius of the temporary center hole 1, θ represents the angle of inclination of the slope, L represents the thickness of the light transmitting layer 12, G represents that the light transmitting layer 12 has no defects but a good surface, NG represents that the light transmitting layer 12 has linear defects and the recessed portion located above the temporary center hole 1 has distortion, A represents that the light transmitting layer 12 has a difference in thickness of less than 4 μm and therefore has no problems in practical use, B represents that the light transmitting layer 12 has a difference in thickness of about 4 μm and has slight problems in practical use, and C represents that the light transmitting layer 12 has a difference in thickness of more than 4 μm and therefore has serious problems in practical use.

TABLE 1

| | | Radius | Angle | | | |
|---|---|---|---|---|---|---|
| | Sub- | of Tem- | of | Light Transmitting Layer | | |
| | strate | porary | Incli- | | | Thick- |
| | Thick- | Center | nation | Thick- | Coating | ness |
| | ness | Hole | θ | ness | Uneven- | Distri- |
| | t (mm) | r (mm) | (degree) | L (μm) | ness | bution |
| Example 1 | 0.1 | 0.5 | 0 | 100 | G | A |
| Example 2 | 0.1 | 1.0 | 2.6 | 100 | G | A |
| Example 3 | 0.1 | 1.5 | 2.8 | 100 | G | A |
| Example 4 | 0.1 | 2.0 | 2.8 | 100 | G | A |
| Example 5 | 0.3 | 0.5 | 0 | 100 | G | A |
| Example 6 | 0.3 | 1.0 | 2.1 | 100 | NG | A |
| Example 7 | 0.3 | 1.5 | 7.1 | 100 | NG | C |
| Example 8 | 0.3 | 2.0 | 11 | 100 | NG | B |
| Example 9 | 0.6 | 0.5 | 0 | 100 | G | A |
| Example 10 | 0.6 | 1.0 | 2 | 100 | NG | A |
| Example 11 | 0.6 | 1.5 | 6.1 | 100 | NG | C |
| Example 12 | 0.6 | 2.0 | 11.3 | 100 | NG | C |
| Example 13 | 1.2 | 0.5 | 0 | 100 | G | A |
| Example 14 | 1.2 | 1.0 | 5.7 | 100 | NG | A |
| Example 15 | 1.2 | 1.5 | 7 | 100 | NG | C |

Table 1 shows that the light transmitting layers 12 that have no coating defects but has uniform thickness can each be formed on corresponding the substrates 10 for small diameter discs by appropriately selecting the temporary center hole diameter with respect to the substrate thickness. Furthermore, the light transmitting layers 12 have superior properties when the angle of inclination is about 5 degrees or less. Since the angle of inclination can be adjusted by controlling the diameter and shape of each temporary center hole 1, rotating conditions, and/or the viscosity of the material for forming the light transmitting layer 3, a uniform light transmitting layer having no coating defects can be obtained by appropriately setting those conditions.

1. A method for manufacturing an optical disc by forming at least one recording layer on a substrate with a temporary center hole and then forming a light transmitting layer on the recording layer, the method comprising:
a step of covering the lower end of the temporary center hole;
a step of providing droplets containing a material for forming the light transmitting layer into the resulting temporary center hole; and
a step of subjecting the material for forming the light transmitting layer to a spin coating process by rotating the substrate.

2. The method according to claim 1 further comprising a step of curing the material for forming the light transmitting layer spread around the temporary center hole in such a manner that the lower end of the temporary center hole is covered.

3. The method according to claim 1, wherein the substrate has a tapered potion of which the thickness is gradually reduced from the inner edge of the recording layer toward the temporary center hole in whole or in part.

4. The method according to claims 1, wherein the substrate is controlled in such a manner that the light transmitting layer formed by curing the material for forming the light transmitting layer subjected to the spin coating process has a recessed portion, located above the temporary center hole, having a slope with an angle of inclination of 7 degrees or less.

5. The method according to claims 1, wherein the lower end of the temporary center hole is covered with a sealing member.

6. An apparatus for manufacturing an optical disc according to a method for manufacturing an optical disc by forming at least one recording layer on a substrate with a temporary center hole and then forming a light transmitting layer on the recording layer, including:
a step of covering the lower end of the temporary center hole;
a step of providing droplets containing a material for forming the light transmitting layer into the resulting temporary center hole; and
a step of subjecting the material for forming the light transmitting layer to a spin coating process by rotating the substrate, the apparatus comprising:
retaining sections for retaining the substrate;
an affixing section for covering the lower end of the temporary center hole; and
a spinner plate.
